(19) United States
(12) Patent Application Publication
(10) Pub. No.: US 2022/0041175 A1
(43) Pub. Date: Feb. 10, 2022

(54) DRIVING CONTROL METHOD OF AUTONOMOUS VEHICLE WITH INTEGRATED CONTROL APPARATUS

(71) Applicants: HYUNDAI MOTOR COMPANY, Seoul (KR); KIA MOTORS CORPORATION, Seoul (KR)

(72) Inventor: Eun Sik Kim, Gwangmyeong-si (KR)

(21) Appl. No.: 17/140,370

(22) Filed: Jan. 4, 2021

(30) Foreign Application Priority Data
Aug. 10, 2020 (KR) 10-2020-0099924

(51) Int. Cl. B60W 50/029; B60W 60/00; B60W 50/02; B60W 50/14

(52) U.S. Cl. CPC B60W 50/029; B60W 60/0015; B60W 60/0051; B60W 50/0205; B60W 2050/0292; B60W 50/14; B60W 2420/52; B60W 2420/42; B60W 2050/146; B60W 60/0053

(57) ABSTRACT

A driving control method of an autonomous vehicle with an integrated control apparatus, which is configured to be operated by a user in a manual driving mode of the autonomous vehicle, includes: an autonomous driving determining operation of determining whether autonomous driving can be continuously performed based on surroundings of the autonomous vehicle; a first determining operation of determining a breakdown of a vehicle driving part in a state where an operation of the autonomous vehicle is stopped from the autonomous driving upon determining that the autonomous driving cannot be performed; and controlling the vehicle to be maintained in a stopped state until the autonomous vehicle is turned off upon determining the breakdown of the autonomous vehicle driving part.

### CROSS REFERENCE TO RELATED APPLICATION

The present application claims priority to Korean Patent Application No. 10-2020-0099924, filed Aug. 10, 2020 in the Korean Intellectual Property Office, the entire contents of which is incorporated herein for all purposes by this reference.

### TECHNICAL FIELD

The present disclosure relates to a driving control method of an autonomous vehicle with an integrated control apparatus, and more particularly, to a technology for controlling a driving method of an autonomous vehicle according to a breakdown of a part of a vehicle and a problem of an external factor of the vehicle when a situation where autonomous driving is impossible occurs during autonomous driving.

### BACKGROUND

An autonomous vehicle is a smart vehicle in which autonomous driving technology is grafted to find a way to a destination by itself even if a driver does not directly operate a steering wheel, an accelerator pedal, a brake, and the like.

When an autonomous driving situation is universally realized, a manual driving mode in which a driver directly takes the wheel and an autonomous driving mode in which the vehicle drives to a destination by itself without the driver directly taking the wheel may be selected.

When an emergency situation occurs during autonomous driving, any one of occupants of a vehicle should manually operate the vehicle, and to this end, the vehicle should be provided with a device the user may operate for a manual driving mode.

As an example, there is a case where a vehicle manager operates a vehicle in a manual driving mode using a device such as a joystick used in a game machine.

The contents described as the related art have been provided only to assist in understanding the background of the present disclosure and should not be considered as corresponding to the related art known to those having ordinary skill in the art.

### SUMMARY

An object of the present disclosure is to provide a method for controlling an operation of an autonomous vehicle according to a breakdown of a vehicle part and a problem of an external factor of a vehicle when a situation where autonomous driving is impossible occurs while an autonomous vehicle with an integrated control apparatus performs autonomous driving, thereby promoting improvement of stability of driving.

According to an embodiment of the present disclosure, a driving control method of an autonomous vehicle with an integrated control apparatus operated by a user in a manual driving mode of the autonomous vehicle includes: an autonomous driving determining operation of determining whether autonomous driving can be continuously performed based on surroundings of the autonomous vehicle; a first determining operation of determining a breakdown of a vehicle driving part in a state where an operation of the autonomous vehicle is stopped from the autonomous driving upon determining that the autonomous driving cannot be performed; and controlling the vehicle to be maintained in a stopped state until the autonomous vehicle is turned off upon determining the breakdown of the autonomous vehicle driving part.

The vehicle driving part may include a chassis part operated by the user for steering, acceleration, braking, and shifting of the vehicle and a powertrain part generating and transmitting driving power of the vehicle, and a vehicle controller provided in the autonomous vehicle may determine whether the vehicle driving part is broken down.

The driving control method may further include: a second determining operation of determining a breakdown of an autonomous driving part provided in the vehicle if it is determined that the vehicle driving part is not broken down in the first determining operation, wherein a first action operation in which the user switches an autonomous driving mode to the manual driving mode and subsequently manually drives to move the vehicle to a destination, while operating the integrated control apparatus, if it is determined that the autonomous driving part is broken down in the second determining operation.

The autonomous driving part of the vehicle may include a radar, a lidar, a camera acquiring image information, and a sensor, wherein a vehicle controller provided in the autonomous vehicle may determine whether the autonomous driving part is broken down.

The first action operation may include a first operation in which the vehicle controller provided in the autonomous vehicle forcibly terminates driving of an autonomous driving system when it is determined that the autonomous driving part is broken down in the second determining operation; a second operation in which a communication connection state of the integrated control apparatus and the vehicle controller after the first operation is checked; and a third operation in which the user switches a driving mode of the vehicle from the autonomous driving mode to the manual driving mode and manually operates to move the vehicle to the destination, while operating the integrated control apparatus.

When driving of the autonomous driving system is forcibly terminated in the first operation, it may be impossible to switch the driving mode of the vehicle to the autonomous driving mode under the control of the vehicle controller.

The integrated control apparatus and the vehicle controller may check a connection state through two communication lines in the second operation, and the third operation may be executed only when the two communication lines are all connected.

The integrated control apparatus may include a portable mobile operation device capable of moving to a desired position while gripped by the user and a fixed display device fixedly installed in an indoor space of the autonomous vehicle, and switching of the driving mode of the vehicle by the user in the third operation may be executed by operating any one of a manual driving mode switch provided in the portable operation device or a manual driving mode switch provided in the fixed display device.

It may be impossible to switch to the autonomous driving mode under the control of the vehicle controller after the user switches the driving mode of the vehicle to the manual driving mode in the third operation.

The driving control method may further include: a third determining operation of determining that an external factor of the vehicle is problematic if it is determined that the autonomous driving part is not broken down in the second determining operation, wherein, in the third determining operation, a second action operation in which the user switches a driving mode of the vehicle from the autonomous driving mode to the manual driving mode and subsequentially manually drives to move the vehicle to a location of a solution of the problem due to the external factor of the vehicle, while operating the integrated control apparatus, may be executed.

The external factor of the vehicle may include a pedestrian located outside the autonomous vehicle and all obstacles excluding the pedestrian, and the vehicle controller provided in the autonomous vehicle may determine that autonomous driving is impossible due to the problem of the external factor of the vehicle.

The second action operation may include a fourth operation in which a communication connection state of the integrated control apparatus and the vehicle controller is checked if it is determined that the external factor of the vehicle is problematic; and a fifth operation in which the user switches the driving mode of the vehicle from the autonomous driving mode to the manual driving mode and manually drives to move the vehicle to the location of the solution of the problem due to the external factor of the vehicle, while operating the integrated control apparatus, when communication between the integrated control apparatus and the vehicle controller is connected through the fourth operation.

In the fourth operation, the integrated control apparatus and the vehicle controller may check the connection state through two communication lines, and the fifth operation may be executed only when the two communication lines are all connected.

The integrated control apparatus may include a portable mobile operation device capable of moving to a desired position while gripped by the user and a fixed display device fixedly installed in an indoor space of the autonomous vehicle, and switching of the driving mode of the vehicle by the user in the fifth operation may be executed by operating any one of a manual driving mode switch provided in the portable operation device or a manual driving mode switch provided in the fixed display device.

After manually driving to move the vehicle to the location of the solution of the problem in the fifth operation, the user may continue to manually drive to move the vehicle to a destination or switch the driving mode from the manual driving mode to the autonomous driving mode to operate the vehicle to the destination by autonomous driving.

### BRIEF DESCRIPTION OF THE DRAWINGS

FIG. 1 is a view of an autonomous vehicle with an integrated control apparatus according to an embodiment of the present disclosure; and

FIG. 2 is a flow chart illustrating a driving control method of an autonomous vehicle with an integrated control apparatus according to an embodiment of the present disclosure.

### DETAILED DESCRIPTION OF THE EMBODIMENTS

While a specific structural or functional description with respect to embodiments according to the present disclosure disclosed in this specification is merely provided for the purpose of describing the embodiments of the present disclosure, there are various modifications capable of replacing the embodiments, and the present disclosure is not limited to the embodiments described in this specification.

While the embodiments according to the present disclosure is susceptible to various modifications and alternative forms, specific embodiments thereof are shown by way of examples in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the invention.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the inventive concept.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present. Other expressions describing a relation between elements, that is, “between” and “directly between”, or “adjacent to” and “directly adjacent to^{˜}”, etc. should be similarly understood.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, terms used here including a technical or scientific term have the same meaning as that which may be generally understood by a person of common skill in the art. Terms defined in a general dictionary among terms used in this document may be analyzed as the same meaning as or a meaning similar to that in a context of related technology, and unless it is clearly defined in this document, the term is not analyzed as having an ideal or excessively formal meaning.

A control unit (controller) according to an embodiment of the present disclosure may be implemented through an algorithm configured to control operations of various components of a vehicle, a nonvolatile memory (not shown) configured to store data related to a software command for reproducing the algorithm, and a processor (not shown) configured to perform an operation described below using the data stored in the corresponding memory. Here, the memory and the processor may be implemented as separate chips. Alternatively, the memory and processor may be implemented as an integrated single chip. The processor may take the form of one or more processors.

Hereinafter, a driving control method of an autonomous vehicle with an integrated control apparatus according to an embodiment of the present disclosure will be descried with reference to the accompanying drawings.

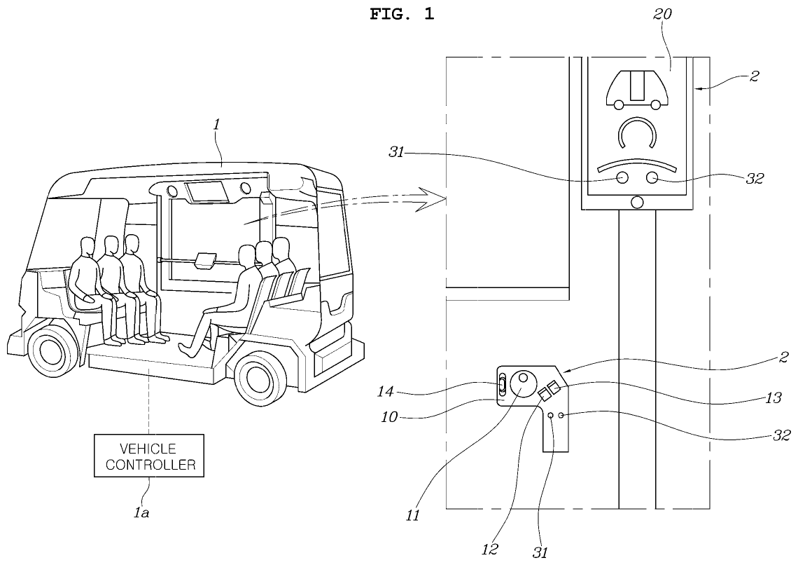

As shown in FIG. 1, an autonomous vehicle 1 is provided with an integrated control apparatus 2 allowing a manager (user or passenger) of a vehicle to directly operate to drive the autonomous vehicle in a manual driving mode.

When an emergency situation where autonomous driving is not possible occurs during autonomous driving, the manager of the vehicle may operate the autonomous vehicle in a manual driving mode using the integrated control apparatus 2.

The integrated control apparatus 2 referred to in an embodiment of the present disclosure includes a mobile operation device 10 operated by the user for steering, shifting, acceleration, and braking in a state where the user grips the integrated control apparatus 2 by hand; and a fixed display device 20 configured to be separated from the mobile operation device 10 and operated by the user in a touch type to operate other functions than steering, shifting, acceleration, and braking.

The mobile operation device 10 is a portable operation device which may be moved to a desired location while being gripped by the user's hand, and the fixed display device 20 is a device fixed and installed in an indoor space of the autonomous vehicle 1. The mobile operation device 10 and the fixed display device 20 are devices having a structure separated from each other.

The mobile operation device 10 may be called a lever-type operation device according to external shapes.

Other functions implemented by the operation of the fixed display device 20 include a driving function of lamps mounted at the front and rear of the vehicle, and a function of generating a warning sound.

The lamps of the vehicle may include all types of lamps mounted on the vehicle and may include headlamps, fog lights, turn signals, tail lights, warning lights, and the like.

The mobile operation device 10 and the fixed display device 20 are configured to transmit and receive signals through a vehicle controller 1a provided in the autonomous vehicle 1 and each of two communication lines.

A normal operation may be performed only when the vehicle controller 1a and both of the two communication lines are connected for a fail-safe function when operating the mobile operation device 10, and if any one of the two communication lines is not connected, the vehicle controller 1a controls the vehicle not to perform the operated function even when the mobile operation device 10 is operated.

The fixed display device 20 is also normally operated only in a state in which both the vehicle controller 1a and the two communication lines are connected for the fail-safe function.

An autonomous driving mode switch 31 and a manual driving mode switch 32 for switching a driving mode of the autonomous vehicle are provided in the mobile operation device 10, in the fixed display device 20, or in both the mobile operation device 10 and the fixed display device 20, as necessary.

In an embodiment according to the present disclosure, steering shifting, acceleration, and braking of the vehicle is performed by operating the mobile operation device 10 corresponding to a portable device and other functions of the vehicle are performed by operating the touch-type fixed display device 20, and thus operation may be easy and convenient. In particular, since various operational functions of the vehicle are separately configured into the mobile operation device 10 and the touch-type fixed display device 20, an erroneous operation may be prevented to a maximum level.

In addition, the mobile operation device 10, which may be a portable device that may be moved to a desired location while being gripped by the user's hand, is relatively small in volume and relatively light in weight so as to be easily operated.

The mobile operation device 10 may include a steering switch 11, an acceleration switch 12, a brake switch 13, and a shifting switch 14, and these switches may be configured as one of a dial switch, a slide switch, and a button switch for the user to easily operate.

A permanent magnet is coupled to each of the steering switch 11, the acceleration switch 12, the brake switch 13, and the shifting switch 14, and a printed circuit board (PCB) is provided to face the permanent magnet in the mobile operation device 10.

Therefore, when the user operates the steering switch 11, the acceleration switch 12, the brake switch 13, the shifting switch 14 provided in the mobile operation device 10, the PCB generates one of a signal related to steering, a signal related to acceleration, a signal related to braking, or a signal related to shifting is generated through a change in magnetic flux according to a change in a position of the permanent magnet.

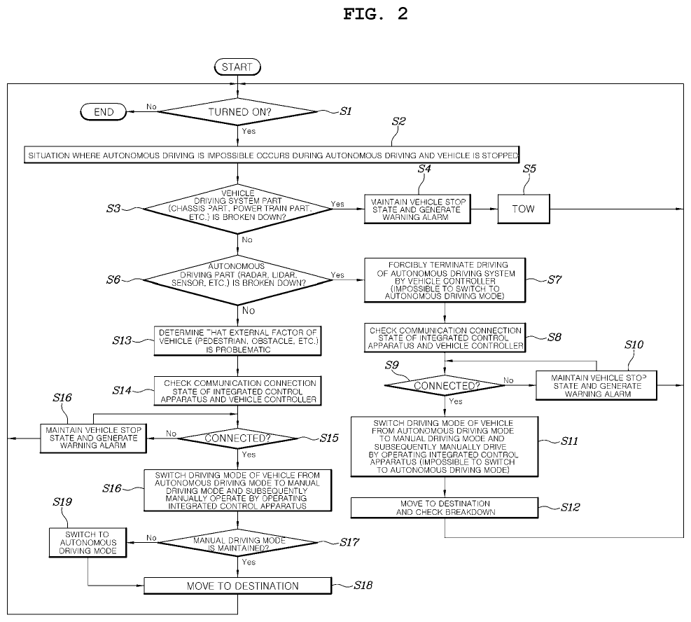

An embodiment according to the present disclosure provides a method of controlling an operation of the autonomous vehicle according to a breakdown of a vehicle part and a problem of an external factor of the vehicle if autonomous driving is impossible in a situation where the autonomous vehicle 1 with the integrated control apparatus 2 as described above is autonomously driving, and details thereof will be described with reference to FIG. 2.

When the autonomous vehicle is turned on (step S1) and if a situation where autonomous driving is impossible occurs during autonomous driving, the vehicle controller 1a forcibly stops the operation of the vehicle and inspects a cause of the inability of autonomous driving (step S2).

A first inspection to be carried out is a first determining operation of determining whether a vehicle driving part is broken down (step S3).

The driving part of the vehicle includes a chassis part operated by the user for steering, acceleration, braking, and shifting of the vehicle and a powertrain part of generating and transmitting driving power of the vehicle, and the vehicle controller 1a provided in the autonomous vehicle 1 determines whether the vehicle driving part is broken down.

If it is determined that the vehicle driving part is broken down as a result of the determination in step S3, a stop state of the vehicle is continuously maintained until the vehicle is turned off in order to prevent an occurrence of damage due to driving, a warning alarm is provided to the user and the passenger through a warning deice (display, warning light, warning sound) of the vehicle (step S4), and the vehicle is finally towed (step S5).

If it is determined that the vehicle driving part is not broken down as the result of the determination in step S3, a second determining operation is performed as a second inspection to determine whether an autonomous driving part is broken down (step S6).

The autonomous driving part of the vehicle includes a radar, a lidar, a camera for acquiring image information, and a sensor, and the vehicle controller 1a of the autonomous vehicle 1 may determine whether the autonomous driving part of the vehicle is broken down.

When it is determined that the vehicle autonomous driving part is broken down as a result of the determination in step S6, the user performs a first action operation in which the user switches the autonomous driving mode to the manual driving mode and subsequently manually operates the vehicle to move to a destination, while operating the integrated control apparatus 2.

That is, if it is determined in step S6 that the autonomous driving part is broken down, a first operation is performed to forcibly terminate the driving of an autonomous driving system through control of the vehicle controller 1a (step S7).

When the driving of the autonomous driving system is forcibly terminated in the first operation, it is impossible to switch the driving mode of the vehicle to the autonomous driving mode under the control of the vehicle controller 1a, whereby the driving mode of the vehicle is maintained in the manual driving mode because it is impossible to switch the driving mode to the autonomous driving mode even if the user operates the autonomous driving mode switch 31.

After the first operation is carried out, a second operation is performed to check a communication connection state of the integrated control apparatus 2 and the vehicle controller 1a (step S8).

The integrated control apparatus 2 and the vehicle controller 1a provided in the autonomous vehicle 1 are configured to transmit and receive signals through CAN communication, and here, the integrated control apparatus 2 and the vehicle controller 1a are configured to transmit and receive signals through two communication lines.

The integrated control apparatus 2 and the vehicle controller 1a are recognized as being normally connected for communication only when the two communication lines are connected for the fail-safe function, and the integrated control apparatus 2 and the vehicle controller 1a are not recognized as being connected for communication if any one of the two communication lines is not connected.

When the communication connection state of the integrated control apparatus 2 and the vehicle controller 1a is checked through the second operation (step S9), if communication between the integrated control apparatus 2 and the vehicle controller 1a is not connected, a stop state of the vehicle is continuously maintained and a warning alarm is simultaneously provided to the user and the passenger through a warning device (display, warning light, warning sound) (step S10).

After the step S10, a logic is fed back to step S9 to repeatedly check a connection state of communication for a certain period of time, and if communication is not connected even after the repeated check for the certain period of time, feedback to step S1 is performed to terminate the logic.

When the communication connection state of the integrated control apparatus 2 and the vehicle controller 1a is checked through the second operation (step S9), if communication between the integrated control apparatus 2 and the vehicle controller 1a is connected, a third operation in which the user switches the driving mode of the vehicle from the autonomous driving mode to the manual driving mode and manually operates to move the vehicle, while operating the integrated control apparatus 2, is performed (step S11).

The switching of the driving mode of the vehicle by the user from the autonomous driving mode to the manual driving mode in the third operation may be performed by operating any one of the manual driving mode switch 32 provided in the mobile operation device 10 or the manual driving mode switch 32 provided in the fixed display device 20.

After the user switches the driving mode of the vehicle to the manual driving mode in the third operation, it is impossible to switch the driving mode of the vehicle to the autonomous driving mode under the control of the vehicle controller 1a, and thus, it is impossible to switch the driving mode of the vehicle to the autonomous driving mode even if the user operates the autonomous driving mode switch 31 and the manual driving mode is maintained.

After the step S11, the vehicle is continuously driven and moved manually to the destination, and thereafter, the autonomous driving part which has been broken down is inspected (step S12).

Upon determining that the vehicle autonomous driving part is not broken down as a result of the determination in step S6, a third determining operation is performed to determine that the autonomous driving is terminated due to a problem of an external factor of the vehicle (step S13).

The external factor of the vehicle includes pedestrians located outside the autonomous vehicle 1 and all obstacles (parked and stopped vehicles, animals, etc.) except for pedestrians, and the vehicle controller 1a provided in the autonomous vehicle 1 determines that autonomous driving is impossible due to a problem of the external factor of the vehicle and thus forcibly terminates the autonomous driving of the vehicle.

After step S13, the user performs a second action operation to manually drive and move the vehicle to a location of a solution of the problem due to the external factor of the vehicle, while operating the integrated control apparatus 2, after the user switches the driving mode of the vehicle from the autonomous driving mode to the manual driving mode.

That is, if the autonomous driving is terminated due to a problem of the external factor of the vehicle through step S13, a fourth operation is performed to check a communication connection state of the integrated control apparatus 2 and the vehicle controller 1a (step S14).

The integrated control apparatus 2 and the vehicle controller 1a provided in the autonomous vehicle 1 are configured to transmit and receive signals through two CAN communication lines.

The integrated control apparatus 2 and the vehicle controller 1a are recognized as being normally connected for communication only when the two communication lines are connected for the fail-safe function, and the integrated control apparatus 2 and the vehicle controller 1a are recognized as not being connected for communication if any one of the two communication lines is not connected.

When the communication connection state of the integrated control apparatus 2 and the vehicle controller 1a is checked through the fourth operation (step S15), if communication between the integrated control apparatus 2 and the vehicle controller 1a is not connected, a stop state of the vehicle is continuously maintained and a warning alarm is simultaneously provided to the user and the passenger through a warning device (display, warning light, warning sound) (step S16).

After the step S16, the logic is fed back to step S15 to repeatedly check a connection state of communication for a certain period of time, and if communication is not connected even after the repeated check for the certain period of time, feedback to step S1 is performed to terminate the logic.

When the communication connection state of the integrated control apparatus 2 and the vehicle controller 1a is checked through the fourth operation (step S15), if communication between the integrated control apparatus 2 and the vehicle controller 1a is connected, a fifth operation in which the user switches the driving mode of the vehicle from the autonomous driving mode to the manual driving mode and manually operates to move the vehicle, while operating the integrated control apparatus 2, to the location of the solution of the problem, is performed (step S16).

The switching of the driving mode of the vehicle by the user from the autonomous driving mode to the manual driving mode in the fifth operation may be performed by operating any one of the manual driving mode switch 32 provided in the mobile operation device 10 or the manual driving mode switch 32 provided in the fixed display device 20.

After manually driving the vehicle to move to the location of the solution of the problem due to the external factor of the vehicle through the fifth operation, the user may continue to manually drive the vehicle to move to the destination (steps S17 and S18) or switch the driving mode from the manual driving mode to the autonomous driving mode (step S19) and operate the vehicle to the destination by autonomous driving.

As described above, the embodiment according to the present disclosure relates to a driving control method for safely operating the autonomous vehicle according to a breakdown of a vehicle driving part, a breakdown of the vehicle autonomous driving part, and an external factor of the vehicle, if a situation where autonomous driving is impossible occurs during autonomous driving of the autonomous vehicle 1 with the integrated control apparatus 2, whereby improvement of stability of driving is promoted.

Although the present disclosure has been shown and described with respect to specific embodiments, it will be apparent to those having ordinary skill in the art that the present disclosure may be variously modified and altered without departing from the spirit and scope of the present disclosure as defined by the following claims.

What is claimed is:

1. A driving control method of an autonomous vehicle with an integrated control apparatus which is configured to be operated by a user in a manual driving mode of the autonomous vehicle, the driving control method comprising:
an autonomous driving determining operation of determining whether autonomous driving can be continuously performed based on surroundings of the autonomous vehicle;
a first determining operation of determining a breakdown of a vehicle driving part in a state where an operation of the autonomous vehicle is stopped from the autonomous driving upon determining that the autonomous driving cannot be performed; and
controlling the vehicle to be maintained in a stopped state until the autonomous vehicle is turned off upon determining the breakdown of the autonomous vehicle driving part.

2. The driving control method of claim 1, wherein the first determining operation includes determining breakdowns of a chassis, which is configured to be operated by the user for steering, acceleration, braking, and shifting of the autonomous vehicle, and a powertrain, which is configured to generate and transmit driving power of the vehicle,
wherein the autonomous vehicle includes a vehicle controller configured to determine the breakdown of the vehicle driving part.

3. The driving control method of claim 1, further comprising:
after the first determining operation, a second determining operation of determining a breakdown of an autonomous driving part of the autonomous vehicle upon determining that the vehicle driving part is normal in the first determining operation; and
upon determining the breakdown of the autonomous driving part in the second determining operation, a first action operation of switching an autonomous driving mode to the manual driving mode to manually drive the autonomous vehicle to a destination by the user, while operating the integrated control apparatus.

4. The driving control method of claim 3, wherein the second determining operation includes determining breakdowns of a radar, a lidar, a camera acquiring image information, and a sensor, and
wherein the autonomous vehicle includes a vehicle controller configured to determine the breakdown of the autonomous driving part.

5. The driving control method of claim 3, wherein the first action operation includes:
a first operation of forcibly terminating, by a vehicle controller, the autonomous driving upon determining the breakdown of the autonomous driving part in the second determining operation;
a second operation of checking a communication connection state of the integrated control apparatus and the vehicle controller; and
a third operation of switching a driving mode of the vehicle from the autonomous driving mode to the manual driving mode by the user to manually drive the vehicle to the destination, while operating the integrated control apparatus.

6. The driving control method of claim 5, further comprising, after the autonomous driving is forcibly terminated, switching, by the vehicle controller, the driving mode of the vehicle to the autonomous driving mode.

7. The driving control method of claim 5, wherein the second operation includes checking a connection state of communication lines between the integrated control apparatus and the vehicle controller, and
wherein the third operation is performed upon determining that the communication lines are connected.

8. The driving control method of claim 5, wherein the integrated control apparatus includes:
a portable mobile operation device configured to be gripped by the user; and
a display device fixedly disposed in an indoor space of the autonomous vehicle, and
wherein the third operation of switching the driving mode by operating any one of a manual driving mode switch of the portable operation device or a manual driving mode switch of the fixed display device.

9. The driving control method of claim 5, wherein, when the driving mode is switched to the manual driving mode by the user in the third operation, the driving mode of the autonomous vehicle is maintained to be the manual driving mode.

10. The driving control method of claim 3, further comprising:
a third determining operation of determining whether an external factor is present upon determining that the autonomous driving part is normal in the second determining operation,
wherein the third determining operation includes a second action operation of switching the driving mode of the vehicle from the autonomous driving mode to the manual driving mode and then manually driving the vehicle to avoid the external factor, while operating the integrated control apparatus.

11. The driving control method of claim 10, wherein the external factor includes a pedestrian located outside the autonomous vehicle and obstacles other than the pedestrian, and
wherein the vehicle controller determines that autonomous driving is impossible upon determining that the external factor is present.

12. The driving control method of claim 10, wherein the second action operation includes:
a fourth operation of checking a communication connection state of the integrated control apparatus and the vehicle controller upon determining that the external factor is present; and
a fifth operation of switching the driving mode of the vehicle from the autonomous driving mode to the manual driving mode to manually drive the vehicle to avoid the external factor, while operating the integrated control apparatus, when communication between the integrated control apparatus and the vehicle controller is connected.

13. The driving control method of claim 12, wherein the fourth operation includes checking the connection state of communication lines between the integrated control apparatus and the vehicle controller, and
wherein the fifth operation is performed upon determining that the communication lines are all connected.

14. The driving control method of claim 12, wherein the integrated control apparatus includes:
a portable mobile operation device configured to be gripped by the user; and
a display device disposed in an indoor space of the autonomous vehicle, and
wherein the fifth operation includes switching the driving mode of the vehicle by operating any one of a manual driving mode switch of the portable operation device or a manual driving mode switch of the fixed display device.

15. The driving control method of claim 12, further comprising, after manually driving the vehicle to avoid the external factor in the fifth operation, manually driving the vehicle by the user to a destination or switching the driving mode from the manual driving mode to the autonomous driving mode to operate the vehicle to the destination by autonomous driving.
